(19) United States
(12) Patent Application Publication
(10) Pub. No.: US 2026/0073051 A1
(43) Pub. Date: Mar. 12, 2026

(54) SECURITY FUNCTION MANAGEMENT DEVICE, METHOD, AND STORAGE MEDIUM

(71) Applicants: DENSO CORPORATION, Kariya-city, Aichi-pref. (JP); TOYOTA JIDOSHA KABUSHIKI KAISHA, Toyota-shi (JP)

(72) Inventors: Ikko SHIMIZU, Kariya-city (JP); Kotaro MIZUNUMA, Kariya-city (JP); Tokuya INAGAKI, Kariya-city (JP); Shogo WATANABE, Kariya-city (JP); Takahiro SHIDAI, Kariya-city (JP); Kunihiro MIYAUCHI, Toyota-shi (JP)

(21) Appl. No.: 19/319,797

(22) Filed: Sep. 5, 2025

(30) Foreign Application Priority Data
Sep. 9, 2024 (JP) 2024-155342

(51) Int. Cl. G06F 21/56

(52) U.S. Cl. CPC G06F 21/566; G06F 2221/034

(57) ABSTRACT

A security function management device is configured to manage execution of a first function, by acquiring a resource requirement, which is an amount of resource required by a second function different from the first function. A usage degree of the second function is acquired. When an attack is detected and execution of the first function is necessary, it is determined whether the resource will be insufficient when executing the first function, based on the resource requirement of the second function. The second function is selected for releasing the resource currently being consumed based on the usage degree and the resource requirement when it is determined that the resource is insufficient. The security function management device outputs an instruction to execute the first function and an instruction to release the resource currently consumed by the second function.

### CROSS REFERENCE TO RELATED APPLICATION

This application is based on Japanese Patent Application No. 2024-155342 filed on Sep. 9, 2024, the disclosure of which is incorporated herein by reference.

### TECHNICAL FIELD

The present disclosure relates to a security function management device, a security function management method, and a storage medium to manage execution of security function of an electronic control unit mounted on a mobile object such as a vehicle.

### BACKGROUND

In recent years, a vehicle is equipped with plural electronic control devices which communicate with and cooperate with each other via an in-vehicle network.

### SUMMARY

According to an aspect of the present disclosure, a security function management device is configured to manage execution of a first function, which is a security function of an electronic control device mounted on a mobile object. The security function management device includes: at least one of (i) a circuit and (ii) a processor with a memory storing computer program code executable by the processor, the at least one of the circuit and the processor configured to cause the security function management device to:
acquire a resource requirement, which is an amount of each resource required by one or more second functions different from the first function and executable by the electronic control device;
acquire a usage degree indicating a degree to which each of the second functions has been used;
determine whether a resource of the electronic control device is insufficient when executing the first function, based on the resource requirement of the second function, when an attack is detected and execution of the first function is necessary;
select the second function for releasing the resource currently being consumed based on the usage degree and the resource requirement of each of the second functions when it is determined that the resource of the electronic control device is insufficient; and
output, to the electronic control device, an execution instruction to execute the first function and a release instruction to release the resource currently being consumed by the selected second function.

### BRIEF DESCRIPTION OF DRAWINGS

FIG. 1 is a diagram showing a configuration of a security function management system common to embodiments of the present disclosure.

FIG. 2 is a diagram showing a main hardware configuration common to the embodiments of the present disclosure.

FIG. 3 is a diagram illustrating a relationship between resources and functions of an electronic control device according to an embodiment.

FIG. 4 is a diagram showing a configuration of a security function management device according to an embodiment.

FIG. 5 is a diagram illustrating a required resource amount acquired by a required resource acquisition unit according to an embodiment.

FIG. 6 is a diagram for explaining usage and priority acquired by a usage acquisition unit according to an embodiment.

FIG. 7 is a diagram for explaining a specific operation of a resource determination unit and a release function selection unit according to an embodiment.

FIG. 8 is a diagram showing a configuration of an electronic control device according to an embodiment.

FIG. 9 is a flowchart showing operation of a security function management device according to an embodiment.

FIG. 10 is a flowchart showing operation of a security function management device according to an embodiment.

FIG. 11 is a flow chart showing operation of an electronic control unit according to an embodiment.

FIG. 12 is a diagram showing usage and priority in a second embodiment.

FIG. 13 is a diagram showing usage and priority in a third embodiment.

### DETAILED DESCRIPTION

In recent years, a vehicle is equipped with plural electronic control devices which communicate with and cooperate with each other via an in-vehicle network. In addition, with the advancement of wireless communication technology and wireless communication network technology, communication technologies that link vehicles with the outside world, such as V2X and connected cars, have become widespread. There are an increasing number of cases where networks that connect external networks to in-vehicle networks are being formed. For this reason, it becomes possible to download software and programs that realize various functions in accordance with user selection, etc. from external providers or center devices into the vehicle via OTA (Over The Air). It is possible to install or update the software and programs in each electronic control unit via the in-vehicle network. While it has become easier to add and update functions to electronic control devices, the possibility of various cyberattacks against the vehicle from outside the vehicle, such as unauthorized program tampering and theft of confidential data, is increasing. Against this background, cybersecurity measures for vehicles are necessary.

A monitoring device that monitors an abnormal condition of a first monitoring target includes a receiving unit and a control unit. The receiving unit receives an abnormality detection result by another monitoring device that monitors an abnormal condition of a second monitoring target different from the first monitoring target. The control unit changes the processing performed by the monitoring device depending on the abnormality detection result by the other monitoring device.

This allows multiple monitoring devices to notify each other of the status of the monitored targets detected by their own devices, enabling each monitoring device to appropriately perform data processing related to the security of the vehicle and also to appropriately adjust or change the manner of that data processing.

The present inventors have found the following issues. To protect against attacks on electronic control devices, it is necessary for the electronic control devices to execute a program having a security function for appropriately dealing with the attacks. However, if the electronic control device is already executing or installing many functions, the electronic control device may not have enough resources to execute a new program with security functions, in which case the security functions cannot be executed.

Furthermore, if the resources are secured by indiscriminately stopping or deleting functions that are already being executed or installed in the electronic control device in order to resolve a resource shortage when executing a security function, the user may be unable to use functions that he or she wants to use or expects from the electronic control device.

The present disclosure provides a security function management device, a security function management method, and a security function management program to enable an electronic control unit to execute security functions against attacks by appropriately securing resources even when the resources of the electronic control unit are insufficient.

According to one aspect of the present disclosure, a security function management device configured to manage execution of a first function, which is a security function of an electronic control device mounted on a mobile object. The security function management device includes:
a required resource acquisition unit configured to acquire a resource requirement, which is an amount of each resource required by one or more second functions different from the first function and executable by the electronic control device;
a usage acquisition unit configured to acquire a usage degree indicating a degree to which each of the second functions has been used;
a resource determination unit configured to, when an attack is detected and execution of the first function is necessary, determine whether a resource of the electronic control device is insufficient when executing the first function, based on the resource requirement of the second function;
a release function selection unit configured to select the second function for releasing the resource currently being consumed based on the usage degree and the resource requirement of each of the second functions when it is determined that the resource of the electronic control device is insufficient; and
an instruction unit configured to output, to the electronic control device, an instruction to execute the first function and an instruction to release the resource currently being consumed by the second function selected by the selection unit.

According to the above configuration, the security function management device can secure the resource of the electronic control device for executing the security function while leaving functions that are likely to be used by the user.

Hereinafter, embodiments of the present disclosure will be described with reference to the drawings.

An invention means an invention described in the claims or the solution to problem, and is not limited to the following embodiments.

Configurations and methods described in the dependent claims are any configurations and methods in the inventions described in the independent claims. Configurations and methods of following embodiments corresponding to configurations and methods described in dependent claims, and configurations and methods described only in the following embodiments without descriptions in claims should be interpreted as arbitrary configurations and arbitrary methods in this disclosure. In a case that the scope of claims is broader than descriptions of the embodiments, configurations and methods described in the following embodiments are just examples of configurations and methods of the present disclosure, which should be interpreted as arbitrary configurations and arbitrary methods in this disclosure. In any case, necessary configurations and methods of the present invention are described in the independent claims.

Any effects described in embodiments may be effects obtained by a configuration of the embodiments as an example of the present disclosure, and may not be necessarily effects of the present disclosure.

In the present disclosure, the configuration disclosed in each embodiment is not limited to each embodiment alone, but may be combined across the embodiments. For example, the configuration disclosed in one embodiment may be combined with other embodiments. The disclosed configurations in respective multiple embodiments may be partially combined with one another. The same applies to the modified examples and embodiments.

The difficulty described above is not a publicly known difficulty but is originally found by the inventors of the present disclosure, and is a fact that confirms non-obviousness of the present disclosure together with a configuration and a method described in the present disclosure.

### 1. Configuration and Functions Common to Embodiments

### (1-1) Overall Configuration of Security Function Management System

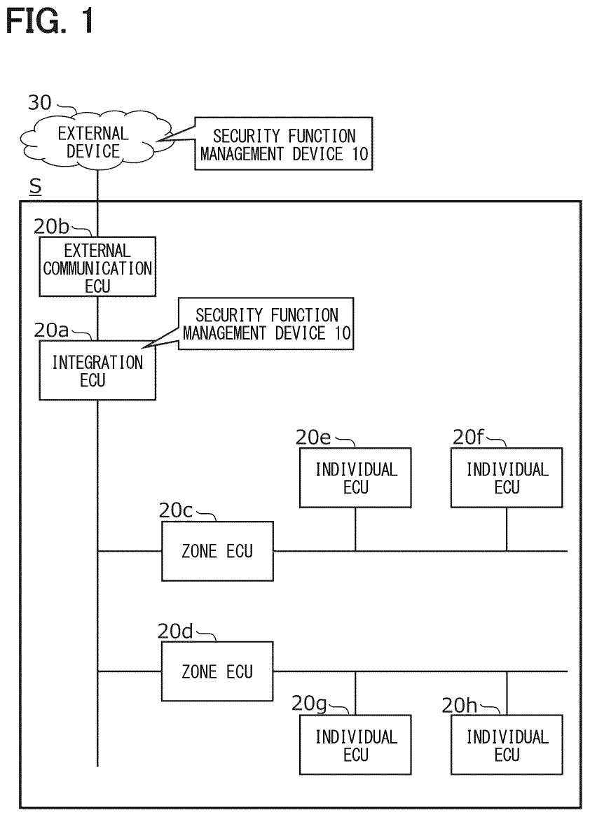

FIG. 1 is a diagram illustrating an example of arrangement of an electronic control unit (ECU) 20 and a security function management device 10 in an electronic control system S mounted on a vehicle.

The electronic control system S and the ECU 20 which is an electronic control device that constitutes the electronic control system S are mounted in a vehicle which is a mobile object in each embodiment. The mobile object means a movable body, and the moving speed is not limited. The mobile object may stop. For example, the mobile body includes, but is not limited to, vehicles, motorcycles, bicycles, pedestrians, ships, aircraft, and objects mounted on these. The term “mounted” includes not only a case where an object is directly fixed to the mobile object but also a case where an object moves together with the mobile object although the object is not fixed to the mobile object. For example, it may be carried by a person on the mobile object, or may be mounted on a load placed on the mobile object. The electronic control unit may be a virtualized electronic control unit implemented using virtualization technology, in addition to a physically independent electronic control unit.

The electronic control system S includes multiple ECUs 20 and an in-vehicle network connecting the multiple ECUs 20. FIG. 1 shows eight ECUs (ECU 20a to ECU 20h) as an example. The electronic control system S may include any number of ECUs. In the following description, the ECU 20 or each ECU 20 will be used when describing a single or multiple electronic control units as a whole, and the ECU 20a, ECU 20b, ECU 20c, etc. will be used when individually describing specific electronic control unit.

In FIG. 1, the ECUs 20 are connected to each other via an in-vehicle communication network such as a Controller Area Network (CAN), a CAN with Flexible Datarate (CAN_FD), a Local Interconnect Network (LIN), or a FlexRay (registered trademark). The ECUs 20 may be connected through any other communication method, whether wired or wireless, such as MOST: Media Oriented System Transport (registered trademark), Ethernet (registered trademark), Wi-Fi (registered trademark), Bluetooth (registered trademark), and the like. The connection refers to a state in which data can be exchanged, and includes a case in which different pieces of hardware are connected via a wired or wireless communication network and a case in which virtual ECUs (alternatively, referred to as virtual machines) implemented on the same piece of hardware are virtually connected.

The electronic control system S illustrated in FIG. 1 includes an integration ECU 20a, an external communication ECU 20b, zone ECUs 20c, 20d, and individual ECUs 20e, 20f, 20g, 20h.

The integration ECU 20a includes a function of controlling the entire electronic control system S and a gateway function for relaying communication among the multiple ECUs 20. The integration ECU 20a may be referred to as a gateway ECU (G-ECU) or a mobility computer (MC). The integration ECU 20a may be a relay device or a gateway device.

The external communication ECU 20b includes a communication unit that communicates with the external device 30 located outside the vehicle. The communication method used by the external communication ECU 20b is a wireless communication method or a wired communication method, which will be described later. In order to implement plural communication methods, the electronic control system S may include plural external communication ECUs 20b. Instead of providing the external communication ECU 20b, the integration ECU 20a may have a function of the external communication ECU 20b. Furthermore, the individual ECUs 20e to 20h may each have a communication function independently.

Each zone ECU 20c, 20d has a gateway function provided according to a function or a location where each individual ECU 20e to 20h is arranged. For example, the zone ECU 20c has a gateway function of relaying communication between the individual ECU 20e, 20f disposed in a front zone of the vehicle and another ECU 20. The zone ECU 20d has a gateway function of relaying communication between the individual ECU 20g, 20h disposed in a rear zone of the vehicle and another ECU 20.

The individual ECUs 20e, 20f, 20g, 20h can be implemented by ECUs having any function. The ECU may be, for example, a drive system electronic control device that controls an engine, a steering wheel, a brake, etc. The ECU may be, for example, a vehicle-body electronic control device that controls a meter, and a power window, etc. The ECU may be, for example, an information-system electronic control device such as a navigation device. The ECU may be, for example, a safety-control electronic control device that controls to prevent a collision with an obstacle or a pedestrian. The ECUs 20 may be classified into a master and a slave instead of parallel arrangement.

The security function management device 10 is a device that manages the execution of the security function (corresponding to a first function) of each ECU 20 in the electronic control system S. The security function management device 10 may be provided either inside or outside the electronic control system S.

For example, the security function management device 10 can be realized by any ECU 20 mounted on a vehicle. For example, since the security function management device 10 is involved in the overall control of the electronic control system S, it is desirable to realize it as an integration ECU 20a that manages each ECU 20 as shown in FIG. 1. However, this does not preclude the implementation of the function using the zone ECU 20c, 20d or the individual ECU 20e to 20h. Also, there is nothing to prevent the implementation by the plural ECUs 20. In each embodiment, for example, the security function management device 10 is realized by the integration ECU 20a.

Alternatively, the security function management device 10 can be realized by a server device installed outside the vehicle, like the external device 30 in FIG. 1. The external device 30 and the external communication ECU 20b of the electronic control system S are connected to each other using a wired communication or a wireless communication. Examples of wired communication include the Internet, fixed telephone lines, and Ethernet (registered trademark). Examples of the wireless communication include, for example, IEEE802.11 (Wi-Fi: registered trademark), IEEE802.16 (WiMAX: registered trademark), W-CDMA (Wideband Code Division Multiple Access), HSPA (High Speed Packet Access), LTE (Long Term Evolution), LTE-A (Long Term Evolution Advanced), 4G, 5G, and the like. Other options include Dedicated Short Range Communication (DSRC), Bluetooth Low Energy (BLE), or Bluetooth (registered trademark). Regarding which communication method is to be used, the most suitable communication method may be adopted depending on the location where the external device 30 is installed, the distance between the external device 30 and the electronic control system S, and the like.

The electronic control devices that are targets of management by the security function management device 10 are the ECUs 20 that are capable of executing a security function (corresponding to a first function). In FIG. 1, the integration ECU 20a, the external communication ECU 20b, the zone ECUs 20c, 20d, and the individual ECUs 20e to 20h are all targets. A specific example of the security function will be described in detail in the first embodiment. The security function management device 10 and the ECU 20 to be managed may be the same ECU. In other words, when the security function management device 10 is realized by the integration ECU 20a, the ECUs 20 to be managed also include the integration ECU 20a. The security function management device 10 and the electronic control devices to be managed are collectively called a security function management system.

The ECU 20 that is the target of management by the security function management device 10 is, for example, a device in which a user of a mobile object can install software as described later. For example, information system electronic control devices such as IVI (In-Vehicle-Information) fall into this category.

### (1-2) Main Hardware Configuration

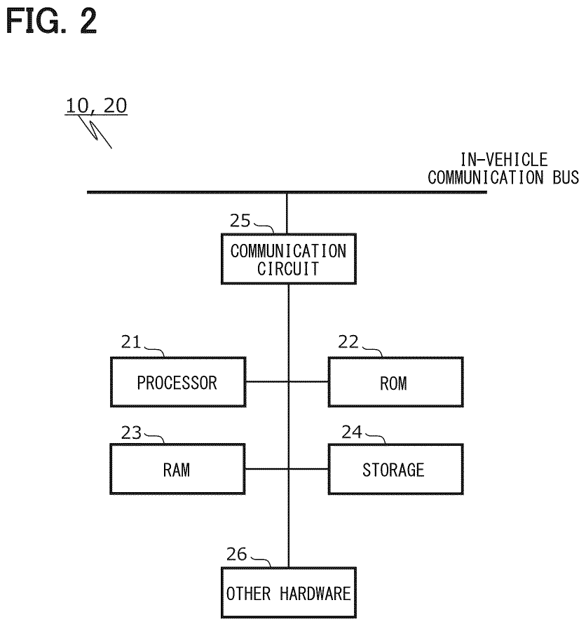

FIG. 2 shows the main hardware configuration of the ECU 20. The ECU 20 includes a processor 21, a ROM 22, a RAM 23, a storage 24, a communication circuit 25, and other hardware 26.

The processor 21 is a processing operation device that executes programs that realize various functions of the ECU 20, and may be a CPU (Central Processing Unit), a DSP (Digital Signal Processor), a GPU (Graphics Processing Unit), or an LSI with an AI core built in. Alternatively, it may be an ASIC (Application Specific Integrated Circuit) or an FPGA (Field Programmable Gate Array) that includes the functions of a processor such as a CPU.

The ROM 22 (Read Only Memory) is a read-only memory device, but what is used as a resource of the present disclosure described below is an erasable, readable and writable memory (corresponding to a non-volatile storage medium) such as a Flash ROM. The ROM 22 mainly stores programs, authentication information, and the like.

The RAM 23 (Random Access Memory) is an erasable, readable and writable memory device (corresponding to a volatile storage medium). The RAM 23 stores part of the program code when the program is executed, working data used by the program, or other temporarily saved data. The RAM 23 may be a dynamic random access memory (DRAM) or a static random access memory (SRAM).

The storage 24 is a memory device (corresponding to a non-volatile storage medium) with a large storage capacity. Examples of the storage 24 include a removable and portable memory, such as a solid state drive (SSD), a universal serial bus (USB) memory, and a hard disk drive (HDD).

The communication circuit 25 communicates with the security function management device 10 and other ECUs 20 via an in-vehicle communication bus.

The other hardware 26 includes digital circuits and analog circuits in the periphery of the processor, as well as hardware necessary for the functions realized by the ECU 20. For example, it may include HMI such as a display or a touch panel, a Global Navigation Satellite System (GNSS) such as GPS, a sensor such as a camera, or a control circuit thereof, or a communication device with the outside such as wireless communication.

The actual hardware of the ECU 20 may be a system on a chip (SOC) in which all or part of the processor 21, ROM 22, RAM 23, etc. are integrated on a single semiconductor chip.

The main hardware configuration of the ECU 20 has been described, but the hardware configuration of the security function management device 10 may be the same.

### (1-3) Resources and Functions of Electronic Control Unit

Next, the resources and functions of the ECU 20 will be described.

The resources of the ECU 20 refer to computer resources necessary for the ECU 20 to realize various functions, and may be physical resources or virtual resources. Examples include resources that perform calculations or data processing according to program code, and resources that temporarily or long-term store program code or data. Specifically, in the case of the ECU 20 in FIG. 2, the processor 21, the ROM 22, the RAM 23, and the storage 24 correspond to resources.

The function of the ECU 20 is a specific role or capability that is realized by consuming resources of the ECU 20 through the execution of a program included in the software. The functions are not necessarily limited to those executed by the entire program, and some functions may be realized by executing at least a part of the program. For example, car navigation is a function that is achieved by executing the entire program of the car navigation system, and generating a guide route to a destination is a function that is achieved by executing a part of a program of the navigation system.

The functions of the ECU 20 are broadly divided into two types according to the role of the ECU. The first is an essential function. The essential function is essential for the ECU 20 to fulfill its purpose or role. For example, when the ECU 20 is for an information system, car navigation, car audio, security functions, and the like may be essential functions. The other is additional function. The additional function is added according to the user's preferences, or/and provided by the ECU 20 as selection options or functions that the user himself installs via the Internet or the like. In the latter example, a third-party application corresponds to an additional function. In the case of the ECU 20 for information system, the examples include a browser, a social networking service (SNS), a platform for streaming services such as games and movies, a scheduler, and the like.

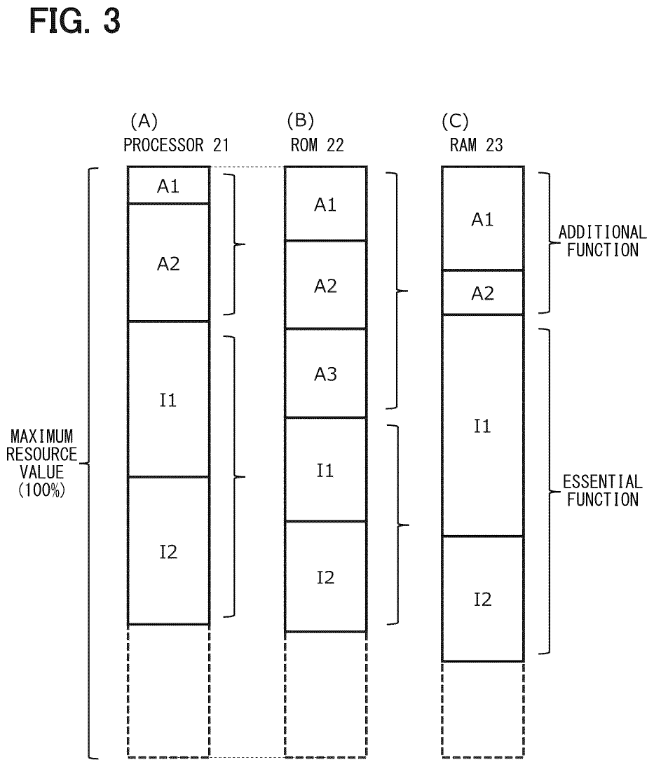

FIG. 3 shows the relationship between the resources and the functions of the ECU 20. In FIG. 3, (A) represents the resource of the processor 21, (B) represents the resource of the ROM 22, and (C) represents the resource of the RAM 23. In each case, the ratio of resources consumed by each function is shown when the maximum processing amount or capacity is set to 100%.

For example, assume that the additional functions A1, A2, A3 and the essential functions I1, I2 are installed. In this case, the resource of the ROM 22 is consumed by storing software having each function in the ROM 22.

When the additional functions A1, A2 and the essential functions I1, I2 are being executed, the programs having the respective functions are loaded in the RAM 23 and the processor 21 and executed. In this case, the resources of the RAM 23 and the processor 21 are not consumed for the additional function A3 that is installed but not executed. In the case of the processor 21 and the RAM 23, the resource consumption varies depending on the execution state of the software, but FIG. 3 shows the maximum consumption.

In this way, if the types of functions installed in the ECU 20 and the execution states of the functions are known, the resource requirement of each resource in the ECU 20 is known. Therefore, by the ECU 20 notifying the security function management device 10 of the resource requirement of each resource, the security function management device 10 can know how much of each resource of the ECU 20 is being consumed.

With regard to the resource consumption, this is the same for both the essential functions and the additional functions; however, as described below, when the ECU 20 needs to free up resources consumed by other functions in order to execute a new security function, the additional functions are candidates for releasing resources, compared with the essential functions.

### 2. First Embodiment

### (2-1) Configuration of Security Function Management Device

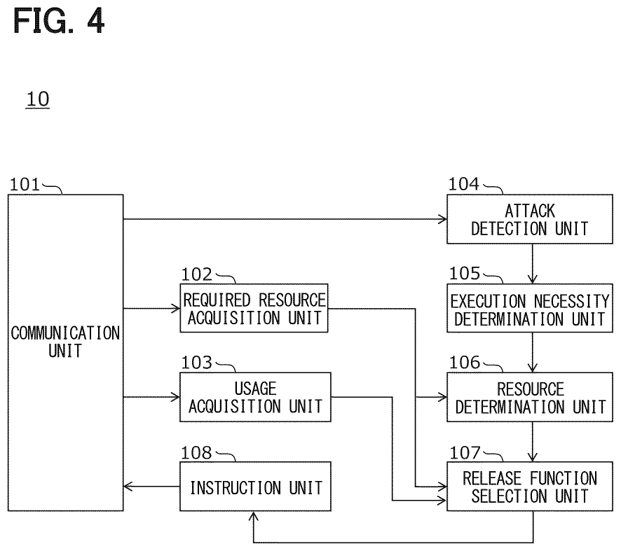

The configuration of the security function management device 10 of the first embodiment will be described with reference to FIG. 4.

The security function management device 10 includes a communication unit 101, a required resource acquisition unit 102, a usage acquisition unit 103, an attack detection unit 104, an execution necessity determination unit 105, a resource determination unit 106, a release function selection unit 107, and an instruction unit 108.

The communication unit 101 communicates with each ECU 20 of the electronic control system S. In addition, the communication ECU 20b communicates with the external device 30 through the communication ECU 20b.

The required resource acquisition unit 102 acquires a required resource amount, which is the amount of resource required by a function that can be executed by the ECU 20. In this embodiment, the amount of resource required by each of one or more second functions different from the first function, which is a security function executed by the ECU 20, is acquired from the ECU 20 that is the management target. The resource requirements are obtained by resource type.

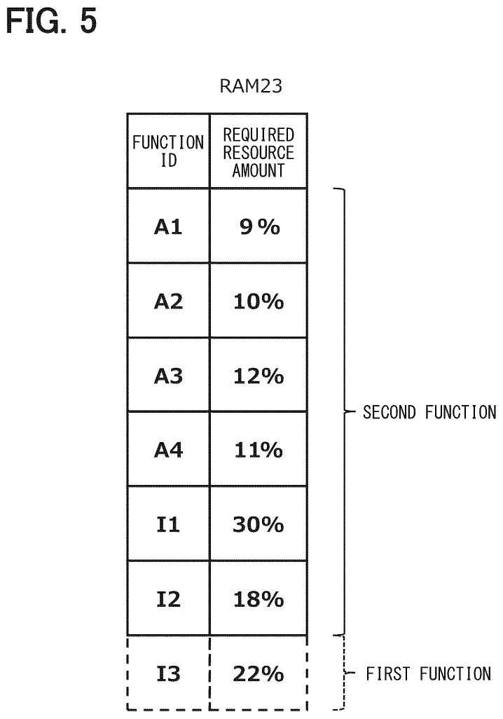

FIG. 5 shows an example of a required resource table in which the required resource amount for each function acquired by the required resource acquisition unit 102 is recorded. In this example, the type of resource is the RAM 23, and the size of the software stored in the RAM of the ECU 20 is shown. The numerical values of the required resource amount in FIG. 5 are normalized with the maximum memory capacity set to 100%. For example, if the maximum memory capacity of the RAM 23 is 10 GB and the resource requirement of the function A2 is 1 GB, then the required resource amount is 10%. Although the resource shown in FIG. 5 is only the RAM 23, the resource requirements of other types of resources such as the processor 21 and the ROM 22 may also be obtained at the same time.

The required resource amount may be obtained when some event occurs or periodically. Examples of the former include when an attack is detected, and when IG is ON or OFF. An example of the latter is obtaining the information at a predetermined time interval, such as every 10 minutes. Also, the information may be acquired at different times depending on the type of resource. For example, the resource may be set according to when each resource is consumed or when the state of each resource changes, such as every 10 minutes for the processor 21, when the program for each function is started for the RAM 23, and when software is downloaded for the ROM 22.

As shown by the dotted line in FIG. 5, the required resource acquisition unit 102 may acquire, in addition to the resource requirement of the second function, the resource requirement of the first function, the need for execution of which is determined by the execution necessity determination unit 105 described below. For example, if there has been a case in the past where the function I3, which is the first function in the ECU 20, consumed the resource, the resource consumption amount may be obtained as the required resource amount. Alternatively, the required resource amount of function I3 may be obtained via communication from an external server or the like that provides the first function.

The usage acquisition unit 103 acquires a usage degree indicating the degree to which each of the second functions has been used. Here, the usage degree is sufficient if it is possible to quantitatively evaluate the usage degree, and examples include the duration of use, the number of times used (including the number of times started), and the usage ratio. In addition to numerical values, the classification may be made by symbols or the like. The term “acquisition” includes not only obtaining by receiving from another device, but also obtaining by generating by oneself.

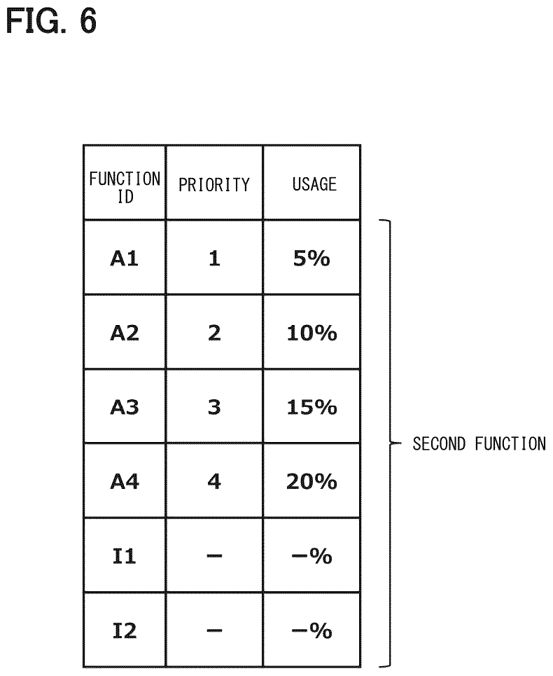

FIG. 6 shows a concrete example of the usage degree of each function. For example, the ECU 20 may measure the usage of each of the second functions in advance, create a usage table as shown in FIG. 6, and transmit it to the security function management device 10, which then receives it. Alternatively, the ECU 20 may transmit an activation flag to the security function management device 10 each time each second function is activated, and the security function management device 10 may receive and compile this to create a usage table such as that shown in FIG. 6.

Any method can be used to calculate the usage degree. For example, the usage rate shown in FIG. 6 is a normalized value obtained by dividing the usage time of each function in the ECU 20 within a given period of time by the usage time of all functions. The usage time can be calculated from the time when the user starts and ends the function.

In the example of FIG. 6, a priority level, which is a priority order for releasing the resource, is associated with the usage degree. In this example, the lower the usage, the higher the priority.

Since the usage degree is obtained in order to determine the priority order when selecting functions for which the resource is to be released, as will be described later, it is sufficient to obtain the usage degree for additional functions among the second functions. That is, it is usually unthinkable to release the resource for the essential functions of the ECU 20. In the example of FIG. 6, the usage rate is not obtained for the essential functions I1, I2.

The attack detection unit 104 detects cyberattacks against the vehicle itself or other vehicles. Examples of attacks include those that exploit vulnerabilities in the vehicle's in-vehicle communication bus protocol to infiltrate the network and generate fraudulent data packets, and those that illegally tamper with software or firmware.

A publicly known method can be used to detect an attack on the vehicle. For example, there is a method of detecting an abnormality by analyzing a log generated by a security sensor of each ECU 20, or a method of detecting an abnormality from the contents or transmission interval of a CAN frame transmitted by each ECU 20. In addition, attacks may be detected by analysis not within the electronic control system S but in a central device or the like installed outside the vehicle. In this case, the attack detection unit 104 detects an attack by receiving a notification of the occurrence of an attack from the center device. When the attack detection unit 104 detects an attack on the host vehicle, the attack detection unit 104 may be provided on the host vehicle as shown in FIG. 6, or may be provided outside the host vehicle.

The method of detecting an attack on another vehicle is the same as the method of detecting an attack on the vehicle itself when the viewpoint is set on the other vehicle. The attack detection unit 104 of the host vehicle detects a cyberattack against another vehicle by receiving an attack occurrence notification of an attack that has occurred in the other vehicle from a center device or the like.

The execution necessity determination unit 105 determines whether or not the ECU 20 should execute a first function, which is a security function, in response to the attack detected by the attack detection unit 104. In other words, when the attack detection unit 104 detects an attack on the vehicle itself or another vehicle, the execution necessity determination unit 105 determines which of the first functions, which are security functions, needs to be executed by which ECU 20. When the attack detection unit 104 detects an attack, the type, characteristics, target of the attack, etc. become clear, so that the execution necessity determination unit 105 can determine whether or not to execute the first function in the ECU 20 that is the target of the attack or is affected by the attack. The execution necessity determination unit 105 may be provided in the vehicle as shown in FIG. 6, or may be provided outside the vehicle.

The first function is a security function when the attack detection unit 104 detects an attack. Therefore, it is desirable for the first function to be responsible for taking measures and dealing with attacks. That is, the first function is a security function that becomes necessary as a result of detecting an attack. Examples of the first function include EPP (Endpoint Protection Platform), which prevents attacks by malicious programs or malware from invading the ECU 20 at the border and records detailed logs for analysis, NGAV (Next Generation AntiVirus), which is an antivirus that detects behavior using AI and machine learning, DPI (Deep Packet Inspection), which inspects not only the headers in data packets but also the data body, and firewall settings against specific attacks.

When the attack detection unit 104 detects an attack on another vehicle by receiving a notification from a center device and it is specified that the first function should be executed during the notification, the execution necessity determination unit 105 determines to execute the first function in accordance with the notification. In this case, the decision as to whether or not a security function needs to be executed is made by a central device outside the vehicle or by a person outside the vehicle.

Either or both of the attack detection unit 104 and the execution necessity determination unit 105 may be provided outside the vehicle. The processing procedure for each case is as follows: (i) When the attack detection unit 104 is provided outside the vehicle and the execution necessity determination unit 105 is provided inside the vehicle, the log and CAN frame generated by the security sensor are transmitted from the vehicle to the outside, and the attack detection unit 104 that receives them detects an attack. Then, the attack detection unit 104 transmits the attack detection result to the host vehicle. (ii) When the attack detection unit 104 is provided inside the host vehicle and the execution necessity determination unit 105 is provided outside the host vehicle, the attack detection result detected by the attack detection unit 104 is transmitted from the host vehicle to the outside of the host vehicle, and the execution necessity determination unit 105 that receives the result determines whether to execute the first function, and the type of the first function to be executed and the location where the function is to be executed. Then, the execution necessity determination unit 105 transmits the determined result to the vehicle. (iii) When the attack detection unit 104 and the execution necessity determination unit 105 are provided outside the vehicle, the log and the CAN frame generated by the security sensor are transmitted from the vehicle to the outside, and the attack detection unit 104 that receives them detects the attack. The attack detection unit 104 transmits the attack detection result to the execution necessity determination unit 105, and the execution necessity determination unit 105 that receives the result determines whether to execute a first function, the type of first function to be executed, and the location where the first function will be executed. Then, the execution necessity determination unit 105 transmits the determined result to the vehicle.

When the attack detection unit 104 and/or the execution necessity determination unit 105 are provided outside the vehicle, the externally provided parts can be performed by a device or a person.

When the attack detection unit 104 detects an attack and the execution necessity determination unit 105 determines that execution of the first function is necessary, the resource determination unit 106 determines whether or not the resource of the ECU 20 will be insufficient when executing the first function, based on the resource requirement of the second function acquired by the required resource acquisition unit 102. In this embodiment, the resource determination unit 106 calculates a total resource requirement by adding the resource requirement required by the first function to all of the resource requirements of the second functions to which resources have been allocated by the ECU 20, and determines whether the ECU 20 will have insufficient resources based on whether the total resource requirement exceeds the maximum resource value possessed by the ECU 20.

More specifically, an appropriate determination method may be determined depending on the type of resource. For example, if the resource is a volatile storage medium that can be erased, read, and written, or a processor, the determination may be made based on the resource requirement of the second function that is currently running. Alternatively, if the resource is an erasable, readable and writable non-volatile storage medium, the determination may be made based on the resource requirement of the second function currently stored in the non-volatile storage medium.

When the resource determination unit 106 determines that the ECU 20 has insufficient resources, the release function selection unit 107 selects second functions that will “release” the currently consuming resources based on the usage and resource requirements of each of the second functions. In this embodiment, as in the example of FIG. 6, the usage acquisition unit 103 obtains a priority table from the ECU 20 in which functions that are currently consuming resources among the second functions are prioritized in ascending order of usage. Then, based on the priority table, the release function selection unit 107 selects functions from which to release resources one by one starting from the second function until the resource determination unit 106 determines that there is no resource shortage. Here, “release” refers to making currently consumed resources available for use.

The second function selected by the release function selection unit 107 is preferably “software” installed by the “user” of the vehicle among the additional functions. The term “user” refers to any person who uses a mobile object, and may be an operator who operates the mobile object, such as a vehicle driver, or a passenger on the mobile object other than the operator. The user may also be a person who uses the electronic control device via communication from outside the mobile object, such as a person who remotely operates the electronic control device. The “software” includes middleware such as an OS.

Similarly, it is preferable that the second function selected by the release function selection unit 107 does not include a function related to “driving” the vehicle. The “driving” includes stopping.

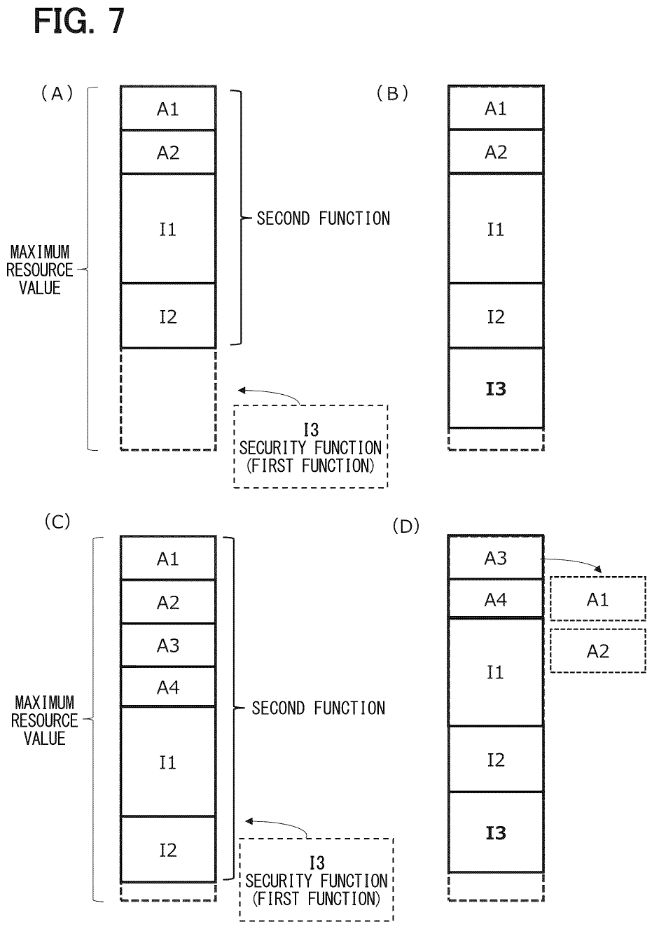

A specific operation example of the resource determination unit 106 and the release function selection unit 107 will be described with reference to FIG. 7. First, it is assumed that the required resource acquisition unit 102 obtains the required resource amount table shown in FIG. 5, and the usage acquisition unit 103 obtains the usage table shown in FIG. 6.

In FIG. 7, a first example will be described with reference to (A) and (B). In the first example, it is assumed that the software for the second function, that is, the functions A1, A2, I1, I2, is stored in the RAM 23. In this state, if the resource is further allocated to the first function, which is the function I3, adding the resource requirement of the function I3 (22%) to the total resource requirement of the four functions already assigned (67%) does not reach the maximum resource value (100%), so the resource can be allocated to all five functions, as shown in (B) of FIG. 7. That is, in the case of (B) of FIG. 7, the first function I3 can be executed without stopping any of the second functions.

A second example will be described with reference to (C) and (D) of FIG. 7. In the second example, it is assumed that the software for the second function, that is, functions A1, A2, A3, A4, I1, I2, is stored in the RAM 23. In this state, if the resource is further allocated to the first function, which is the function I3, the sum of the total resource requirements of the six already assigned functions (90%) plus the resource requirement of function I3 (22%) will exceed the maximum resource value (100%), so that the resource cannot be allocated to the first function I3 in this state. Therefore, from among the six already allocated second functions, a second function for which resources are to be released is selected in order of least frequent use, that is, in order of highest priority in the example of FIG. 6. In the example of FIG. 6, the function A1, which has the highest priority, is selected first, but since the function A1 alone is still not enough, the function A2, which has the next highest priority, is also selected. Furthermore, since the sum of the resource requirements of the four functions excluding functions A1, A2 (71%) plus the resource requirements of the function I3 (22%) does not exceed the maximum resource value (100%), the resource can be allocated to the function I3 as shown in (D) of FIG. 7.

Although FIG. 7 shows only the RAM 23 as an example of a resource type, the same applies to other types of resources. Furthermore, when there are multiple types of resources, adjustments similar to those in FIG. 7 may be made for each resource so that none of the resources exceed 100%.

As shown in FIG. 4, the instruction unit 108 outputs to the ECU 20 an “execution instruction” for the first function and a “release instruction” which is an instruction to release the resource currently being consumed by the second function selected by the release function selection unit 107. The “execution instruction” includes an instruction to execute a first function that has already been installed, as well as an instruction to install and execute a first function that has not yet been installed. The “release instruction” includes a direct instruction to release resources as well as a case where resources are released as a result of a specified instruction. An example of the former is an erase command for ROM or a hard disk (i.e., a command to release ROM or storage resources), and an example of the latter is an end command for a program (i.e., a command to release processor or RAM resources).

Concerning the release instruction, specifically, an appropriate instruction may be determined according to the type of resource. For example, when the resource is an erasable, readable and writable volatile storage medium or a processor, an instruction to terminate the second function selected by the release function selection unit 107 is output as a release instruction. Alternatively, if the resource is an erasable, readable and writable non-volatile storage medium, a command to erase the second function selected by the release function selection unit 107 is output as a release instruction.

If the first function has not yet been installed in the ECU 20, software for implementing the first function may be transmitted in addition to the execution instruction. In this case, it is preferable that the resource determination unit 106 determines in advance whether or not the resources of the ROM 22 will be insufficient.

### (2-2) Configuration of Electronic Control Unit

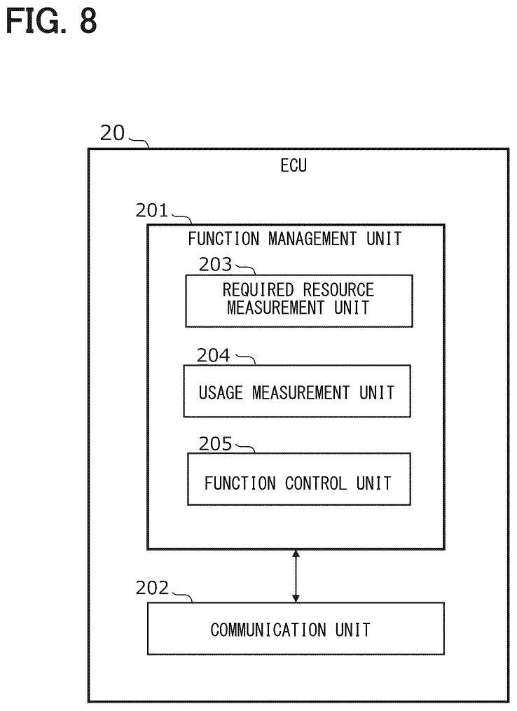

The configuration of the ECU 20 of the first embodiment will be described with reference to FIG. 8. The ECU 20 has a function management unit 201 and a communication unit 202. The function management unit 201 includes a required resource measurement unit 203, a usage measurement unit 204, and a function control unit 205.

The communication unit 202 communicates with the security function management device 10. Specifically, the information on the resource requirement and usage is transmitted to the security function management device 10. The communication unit 202 receives an execution instruction and a release instruction from the security function management device 10.

The required resource measurement unit 203 measures the required resource amount for each of the functions executed by the ECU 20. A specific example is as explained with reference to FIG. 5. The resource requirement can be an average or maximum value of the measured values of the consumed resources. The required resource measurement unit 203 measures the required resource amount, so that information on the required resource amount can be obtained at the required timing.

The required resource amount may be provided in advance as an estimated value when the ECU 20 is manufactured or when a function is provided from an external device such as a central device. For example, in FIG. 5, if the first function, which is the function I3, is not initially executed by the ECU 20, the required resource measurement unit 203 cannot measure the resource requirement, so an estimated value provided from outside can be used.

The usage measurement unit 204 measures the usage indicating the degree to which each of the second functions has been used. A specific example is as explained with reference to FIG. 6.

The function control unit 205 controls the installation, execution, termination, and deletion of software that realizes the functions of the ECU 20. As a result, the resources of the ECU 20 are allocated or released. In this embodiment, software for realizing each function is installed, executed, terminated, or deleted in accordance with an execution instruction or release instruction sent from the security function management device 10.

### (2-3) Operation of Security Function Management Device

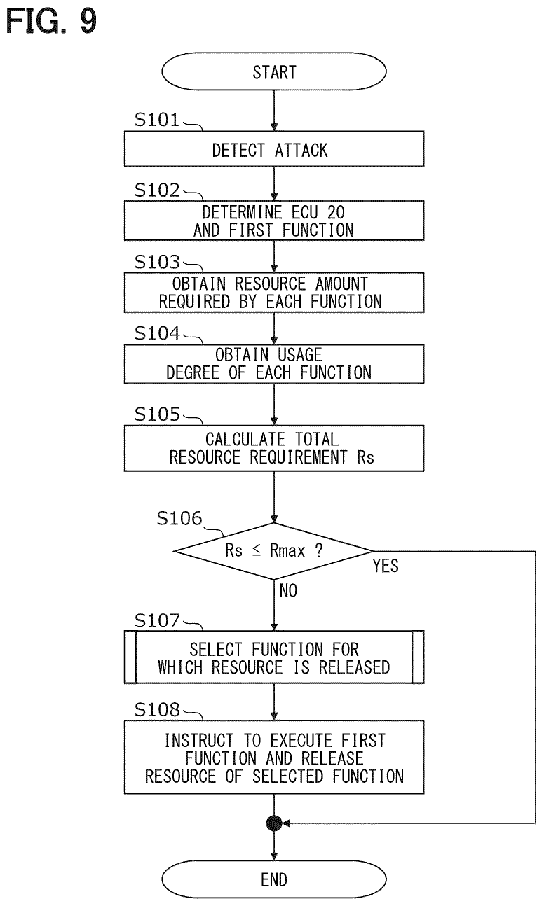

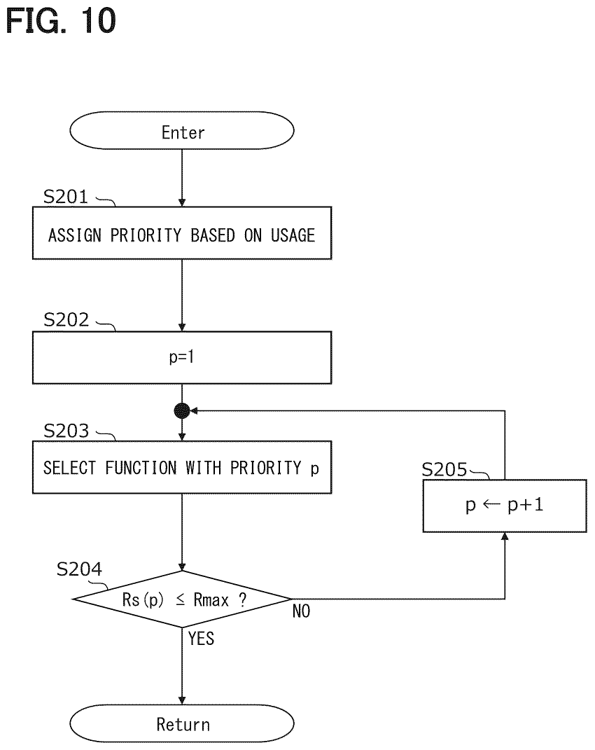

The operation of the security function management device 10 of the present embodiment will be described with reference to the flowcharts of FIGS. 9 and 10. The following operations not only indicate the methods executed by the security function management device 10 but also indicate the processing procedures of programs that can be executed by these devices.

FIG. 9 shows a main routine when an attack on the vehicle is detected. The attack detection unit 104 detects an attack on the vehicle itself or another vehicle (S101). When an attack is detected in S101, the execution necessity determination unit 105 determines a first function to be executed and an ECU 20 that executes the first function (S102). There may be plural first functions and plural ECUs 20. In other words, when there are plural ECUs 20, one or plural first functions may be determined for each ECU 20. The required resource acquisition unit 102 obtains, from the ECU 20, the required resource amounts required by each of the one or more second functions (S103). The usage acquisition unit 103 obtains the usage degree of each of the second functions from the ECU 20 (S104). The resource determination unit 106 determines whether or not the resources of the ECU 20 will be insufficient when executing the first function, based on the required resource amount obtained in S103 (S105, S106). That is, the resource requirements are calculated for all second functions that are currently consuming resources, and the total required resource amount Rs is calculated by adding the resource requirement of the first function determined in S102 to the sum of the calculated resource requirements (S105). Then, the total required resource amount Rs is compared with a maximum resource value Rmax, which is the maximum value of the resource that can be consumed (S106). If the total required resource amount Rs is equal to or less than Rmax (S106: y), the process ends. If the total required resource amount Rs is greater than Rmax (S106: n), the process proceeds to S107. The release function selection unit 107 selects a function for which resources are to be released from among the second functions, based on the required resource amount acquired in S103 and the usage degree acquired in S104 (S107). The instruction unit 108 outputs to the ECU 20 an instruction to execute the first function and an instruction to release the resource of the second function selected in S107 (S108).

FIG. 10 shows a subroutine for executing step S107. Based on the usage degree of the second functions acquired in S104, a priority level, which is the order in which resources are released, is assigned to each of the second functions (S201). The priority is set to p, and p is set to 1 (S202). The second function with the priority p is selected (S203). The total required resource amount Rs (p) obtained by subtracting the resource requirement of the second function selected in S203 from the total required resource amount Rs is compared with the maximum value Rmax (S204). When the total required resource amount Rs (p) is equal to or less than Rmax (S204: y), it is determined that the resource shortage has been resolved and the subroutine is terminated. When the total required resource amount Rs (p) is greater than Rmax (S204: n), the resource shortage has not yet been resolved, so p is incremented (S205) and the process returns to S203. In other words, the range of selection is expanded from high priority to low priority until the resource shortage is resolved. For example, if the resource shortage is resolved when p=3, functions with priorities p of 1, 2, and 3 will have been selected.

In FIG. 9, after an attack is detected in S101, the required resource amount is acquired in S103 and the usage degree is acquired in S104. However, the required resource amount and the usage degree may be acquired in advance before an attack is detected. In this case, the processes are performed in the order of S103, S104, S101, and S102. In this case, since the ECU 20 that executes the first function has not yet been determined, it is preferable to periodically obtain the resource requirements and utilization of all the ECUs 20. Furthermore, the priority in step S201 may be assigned in advance in step S104. Alternatively, the ECU 20 may measure the usage degree and obtain a value to which a priority has been assigned in advance. In these cases, the process of S201 is not necessary. When plural first functions are selected in S102, the sum of the resource requirements of the selected first functions is used as the resource requirement of the first function in S105. Moreover, when plural ECUs 20 are selected in S102, each ECU 20 may execute the flows of FIG. 9 and FIG. 10.

### (2-4) Operation of Electronic Control Unit

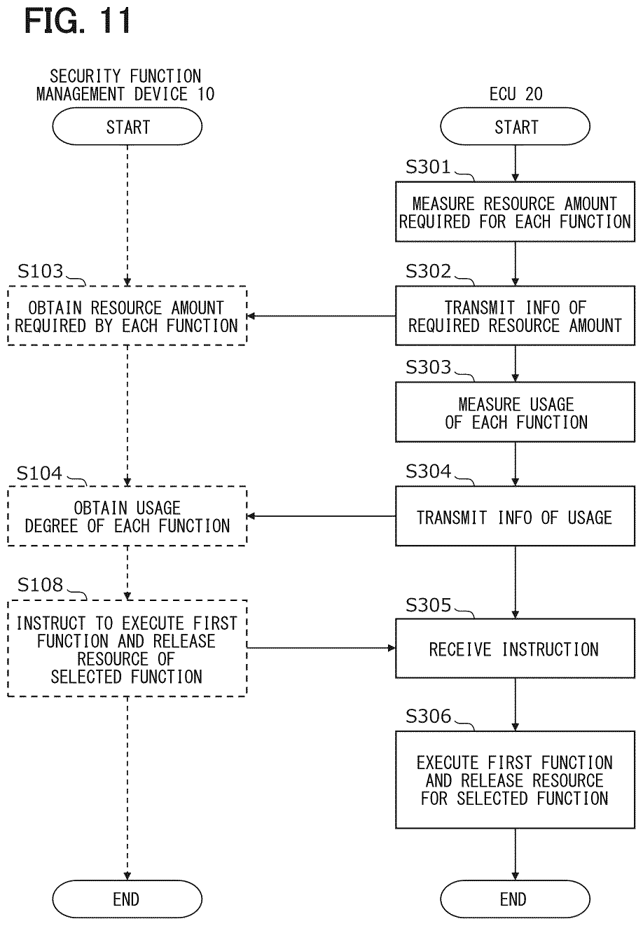

Next, the operation of the ECU 20 of the present embodiment will be described with reference to the flowchart of FIG. 11.

The required resource measurement unit 203 of the ECU 20 measures the required resource amount for each second function (S301). The communication unit 202 of the ECU 20 transmits the required resource amount measured in S301 to the security function management device 10 (S302). As a result, the required resource acquisition unit 102 of the security function management device 10 acquires the resource requirement (S103).

The usage measurement unit 204 of the ECU 20 measures the usage of each of the second functions in the ECU 20 (S303). The communication unit 202 of the ECU 20 transmits the usage measured in S303 to the security function management device 10 (S304). As a result, the usage acquisition unit 103 of the security function management device 10 obtains the usage degree (S104). The instruction unit 108 of the security function management device 10 outputs an instruction to execute the first function and an instruction to release the resources of the selected second function (S108), and the communication unit 202 of the ECU 20 receives the output (S305). The function control unit 205 of the ECU 20 allocates resources to the first function, executes the first function, and releases resources for the instructed function out of the second functions (S306).

### (2-5) Summary

As described above, the security function management device 10 of this embodiment selects functions for which the resources should be released based on the usage degree and instructs the release of the resources. Therefore, even if the ECU 20 does not have sufficient resources to execute a security function, it is possible to secure resources for executing the security function while leaving functions in the ECU 20 that are highly used (i.e., functions that are likely to be used by the user). The security function management device 10 of this embodiment selects the second functions to be released in ascending order of frequency of use, and therefore can terminate or erase the execution of functions that are unlikely to be used by the user in ascending order of frequency of use. In the security function management device 10 of this embodiment, the second function of releasing resources is software installed by the vehicle user, so there is no need to select essential functions of the ECU 20, and resources for functions essential to the ECU 20 can be conserved. In this embodiment, the security function management device 10 does not include functions related to vehicle operation in the second function that releases resources, so essential functions of the ECU 20 are not selected, and resources for functions that are indispensable for the ECU 20 can be conserved.

### 3. Second Embodiment

In the first embodiment, the security function management device 10 obtains the usage degree of each function from the ECU 20, and selects functions for which resources are to be released based on this. However, the information received from a potentially compromised ECU 20 may not be trustworthy. Therefore, in this embodiment, a security function management device 10 capable of selecting a function for releasing resources by using reliable information will be described. Below, configurations different from the first embodiment will be described, and the description of the first embodiment will be quoted for configurations common to the first embodiment.

### (3-1) Example 1 (Information Acquisition Timing)

The usage acquisition unit 103 acquires the usage degree from the ECU 20 periodically or when an event other than an attack occurs, regardless of the detection of an attack. The release function selection unit 107 selects a second function for which resources are to be released, based on the usage acquired by the usage acquisition unit 103 before the attack is detected.

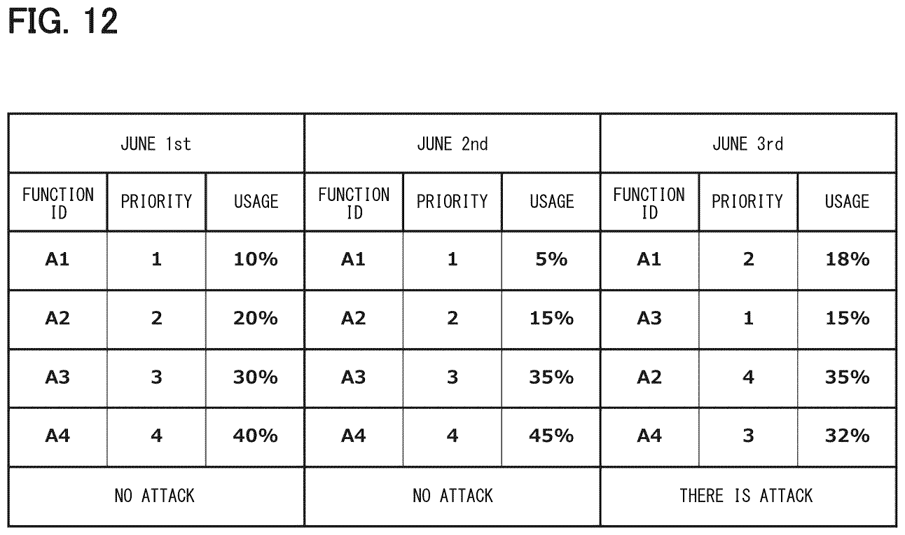

FIG. 12 shows an example of the usage acquired by the usage acquisition unit 103 of this embodiment. In FIG. 12, the usage acquisition unit 103 acquires the usage degree once a day, for example, at 6 am. For example, if an attack on the vehicle is detected at 5:00 a.m. on June 3rd, the release function selection unit 107 selects the second function to release resources using the usage and priority on June 2nd rather than the usage and priority on June 3rd, taking into account the possibility that the usage and priority on June 3rd may have been affected by the attack and may be different from the original values.

In consideration of the case where it takes some time for an attack to become apparent, the usage and priority obtained a predetermined time before the attack was detected may be used. For example, when using the usage and priority acquired more than 24 hours before the attack was detected, the usage and priority on June 1st are used in FIG. 12.

Alternatively, the average usage before the attack may be calculated, and the priority may be calculated based on this average usage. For example, in the example of FIG. 12, if the average values of the usage on June 1st and June 2nd are used, the average usage and priority of each function will be as follows: The number in parentheses is the priority.

A1: 7.5% (1)

A2: 17.5% (2)

A3: 32.5% (3)

A4: 42.5% (4)

Similarly, with regard to the resource requirement obtained from the ECU 20, the required resource acquisition unit 102 may acquire the resource requirement from the ECU 20 periodically or when an event other than an attack occurs, regardless of the detection of an attack. The release function selection unit 107 may select a second function to release resources based on the resource requirement acquired by the required resource acquisition unit 102 before detecting an attack.

As described above, the security function management device 10 of this embodiment selects the second function to release the resource based on information acquired before detecting an attack. Therefore, it is possible to select the second function to release the resource using information that is not affected by the attack.

### (3-2) Example 2 (Information Storage Location)

In the security function management device 10 of the first embodiment, the second function for releasing resources is selected using the usage rate and the required amount of resources stored in the security function management device 10. However, when an attack on the vehicle is detected, there is a possibility that not only the ECU 20 but also the ECU implementing the security function management device 10 and the connected storage devices may be affected by the attack. Therefore, in this embodiment, the information is stored outside the vehicle.

The required resource acquisition unit 102 stores the acquired required resource amount in an external device installed outside the mobile object. For example, the resource requirement table shown in FIG. 5 is stored in an external device. The usage acquisition unit 103 stores the acquired usage degree in an external device installed outside the mobile object. For example, the usage table of FIG. 6 is stored in an external device. The release function selection unit 107 selects a second function based on the usage and required resource amount obtained from the external device.

Only one of the usage degree and the resource requirement may be stored in the external device. Moreover, the first and second embodiments may be combined. That is, the release function selection unit 107 may select the second function based on information acquired before detecting an attack, from information stored externally.

As described above, the security function management device 10 of this embodiment selects the second function to release the resource based on information stored externally, and is therefore able to select the second function that releases resources using information that is not affected by an attack.

### 4. Third Embodiment

In the first embodiment, the usage degree is acquired without distinguishing between users of the vehicle. In the present embodiment, when there are multiple users of the vehicle, the users are distinguished from one another. Below, configurations different from the first embodiment will be described, and the description of the first embodiment will be quoted for configurations common to the first embodiment.

When plural users use the vehicle or the ECU 20, the usage acquisition unit 103 acquires the usage degree for each user. The release function selection unit 107 selects a second function for releasing resources based on the usage degree of the user currently using the vehicle or ECU 20 at the time of determination or selection by the execution necessity determination unit 105, the resource determination unit 106, or the release function selection unit 107.

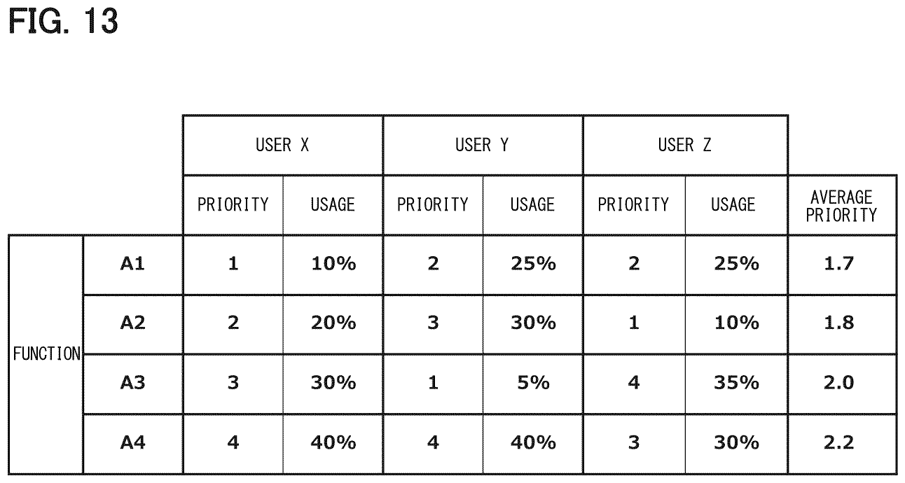

FIG. 13 shows an example of the usage acquired by the usage acquisition unit 103 of this embodiment. In FIG. 13, the usage acquisition unit 103 acquires the usage degree measured for each of users X, Y, Z. Any method can be used to identify the user. For example, the user may be identified using the username and password used at login or credit card information, or the user may be identified using image recognition technology from an image captured by a camera installed in the vehicle.

For example, assume that the user X uses the vehicle or the ECU 20 at the time when an attack on the vehicle is detected and it is determined that a security function against the attack should be executed. In this case, the release function selection unit 107 generates a priority based on the usage of the user X in the usage table of FIG. 13, and selects the second function for which resources are to be released based on the generated priority.

In the above example, a function is selected based on the usage degree by one user. However, if multiple users use the function at the same time, the average usage degree, which is an average value of usage degrees by the multiple users, or an average priority calculated from the average usage degree may be used. For example, if the users X, Y, and Z all used the service at the same time, the average priority calculated from the average usage degree of the three users, as shown in FIG. 13, is used. The average value may be a geometric mean or an arithmetic mean. The average priority in FIG. 13 is an example of the geometric mean of the priorities of the users X, Y, Z.

Alternatively, the average value may be calculated using a weighted value according to the usage degree of the user who is currently using the device.

As described above, in case where a vehicle or ECU 20 is used by multiple different users, when it is necessary to release the resources of one of the second functions to execute a security function, the security function management device 10 of this embodiment can retain the functions that are likely to be used by the user currently using the vehicle or ECU 20, thereby further increasing user satisfaction.

### 5. Summary

The security function management device 10 according to the embodiments of the present disclosure has been described.

Since the terms used in each embodiment are examples, the terms may be replaced with terms that are synonymous or include synonymous functions.

The block diagrams used for the description of the embodiments are obtained by classifying and arranging the configurations of the device for each function. The blocks representing the respective functions may be implemented by any combination of hardware or software. Further, since the block diagrams illustrate the functions, the block diagrams can be understood as disclosure of the method and the program that implements the method.

Functional blocks that can be understood as processes, flows, and methods described in the respective embodiments may be changed in order as long as there is no restrictions such as a relationship in which results of preceding other steps are used in one step.

The terms such as first, second, to N-th (where N is an integer) used in each embodiment and in the claims are used to distinguish two or more configurations and methods of the same kind and are not intended to limit the order or superiority.

Although each embodiment is described under a condition that a device is mounted on a vehicle, the present disclosure also includes dedicated or general-purpose device other than the device for vehicle use purpose, unless otherwise limited in the claims.

Further, examples of the device described in the present disclosure include the following. Examples of the component include a semiconductor element, a semiconductor circuit, an electronic circuit, a module, and a microcomputer. Examples of semi-finished product include an electronic control unit (ECU), an electronic control unit, and a system board. Examples of completed product according to the present disclosure include a mobile router, a mobile phone, a smartphone, a tablet, a personal computer (PC), a workstation, and a server.

Necessary functions such as an antenna or a communication interface may be added to the devices.

It is envisioned that the device of the present disclosure will be used for the purpose of providing various services. In providing such services, the device of the present disclosure is used, the method of the present disclosure is employed, and/or the program of the present disclosure is executed.

In addition, the present disclosure can be implemented by not only dedicated hardware having the configurations and functions described in each embodiment but also as a combination of a program recorded in a storage medium such as a memory or a hard disk and provided to implement the present disclosure, and general-purpose hardware having a dedicated or general-purpose CPU, which can execute the program, and having a memory and the like.

A program for the device of the present disclosure, which is stored in a non-transitory, tangible storage medium (e.g., an external storage device (hard disk, USB memory, CD/BD, etc.) or an internal storage device (RAM, ROM, etc.)) of dedicated or general-purpose hardware, can also be provided to the dedicated or general-purpose hardware via the storage medium, or via a communication line from a server without via a storage medium. As a result, it is possible to provide a latest function by updating the program.

The security function management device of the present disclosure can be widely applied to security function management in motorcycles, electric bicycles, ships, aircrafts, and the like.

What is claimed is:

1. A security function management device configured to manage execution of a first function, which is a security function of an electronic control device mounted on a mobile object, comprising:
at least one of (i) a circuit and (ii) a processor with a memory storing computer program code executable by the processor, the at least one of the circuit and the processor configured to cause the security function management device to:
acquire a resource requirement, which is an amount of each resource required by one or more second functions different from the first function and executable by the electronic control device;
acquire a usage degree indicating a degree to which each of the second functions has been used;
determine whether a resource of the electronic control device is insufficient when executing the first function, based on the resource requirement of the second function, when an attack is detected and execution of the first function is necessary;
select the second function for releasing the resource currently being consumed based on the usage degree and the resource requirement of each of the second functions when it is determined that the resource of the electronic control device is insufficient; and
output, to the electronic control device, an execution instruction to execute the first function and a release instruction to release the resource currently consumed by the selected second function.

2. The security function management device according to claim 1, wherein the second function to be released is selected in an ascending order of the usage degree.

3. The security function management device according to claim 1, wherein
when the resource is an erasable, readable and writable volatile storage medium or a processor, a determination is made based on the resource requirement of the second function currently being activated, and
as the release instruction, a command is output to terminate the selected second function.

4. The security function management device according to claim 1, wherein
when the resource is an erasable, readable and writable non-volatile storage medium, a determination is made based on the resource requirement of the second function currently stored in the non-volatile storage medium; and
as the release instruction, a command is output to delete the selected second function.

5. The security function management device according to claim 1, wherein the first function is a security function that is necessary as a result of detecting the attack.

6. The security function management device according to claim 1, wherein the selected second function is software installed by a user of the mobile object.

7. The security function management device according to claim 6, wherein the mobile object is a vehicle, and the second function does not include a function related to a driving of the vehicle.

8. The security function management device according to claim 1, wherein the second function is selected based on the usage degree acquired before the attack is detected.

9. The security function management device according to claim 1, wherein
the acquired usage degree is stored in an external device installed outside the mobile object, and
the second function is selected based on the usage degree acquired from the external device.

10. The security function management device according to claim 1, wherein
when the mobile object is used by a plurality of users, the usage degree is acquired for each of the users, and
the second function is selected based on the usage degree of a user currently using the mobile object.

11. The security function management device according to claim 1, wherein
when the mobile object is used by a plurality of users, the usage degree is acquired for each of the users, and
the second function is selected based on an average usage degree that is an average value of usage degrees.

12. The security function management device according to claim 1, wherein the security function management device is an electronic control device mounted on the mobile object.

13. The security function management device according to claim 1, wherein security function management device is a server device installed outside the mobile object.

14. A method executed by a security function management device that manages execution of a first function, which is a security function of an electronic control device mounted on a mobile object, the method comprising:
acquiring a resource requirement, which is an amount of each resource required by one or more second functions different from the first function and executable by the electronic control device;
acquiring a usage degree indicating a degree to which each of the second functions has been used;
determining whether a resource of the electronic control device is insufficient when executing the first function, based on the resource requirement of the second function, when an attack is detected and execution of the first function is necessary;
selecting the second function for releasing the resource currently being consumed based on the usage degree and the resource requirement of each of the second functions when it is determined that the resource of the electronic control device is insufficient; and
outputting, to the electronic control device, an execution instruction to execute the first function and a release instruction to release the resource currently consumed by the selected second function.

15. A non-transitory computer readable storage medium storing a security function management program that manages execution of a first function, which is a security function of an electronic control device mounted on a mobile object, and comprising instructions configured to, when executed by a computer, cause the computer to
acquire a resource requirement, which is an amount of each resource required by one or more second functions different from the first function and executable by the electronic control device;
acquire a usage degree indicating a degree to which each of the second functions has been used;
determine whether a resource of the electronic control device is insufficient when executing the first function, based on the resource requirement of the second function, when an attack is detected and execution of the first function is necessary;
select the second function for releasing the resource currently being consumed based on the usage degree and the resource requirement of each of the second functions, when it is determined that the resource of the electronic control device is insufficient; and
output, to the electronic control device, an execution instruction to execute the first function and a release instruction to release the resource currently consumed by the selected second function.
